(19) United States
(12) Patent Application Publication
(10) Pub. No.: US 2022/0309782 A1
(43) Pub. Date: Sep. 29, 2022

(54) USING SMARTPHONE CAMERA AND APPLICATION TO CAPTURE, ANALYZE, AND EVALUATE LATENT FINGERPRINTS IN REAL-TIME

(71) Applicant: Sam Houston State University, Huntsville, TX (US)

(72) Inventors: Mingkui Wei, Huntsville, TX (US); Chi Chung Yu, Conroe, TX (US)

(21) Appl. No.: 17/706,532

(22) Filed: Mar. 28, 2022

Related U.S. Application Data
(60) Provisional application No. 63/166,595, filed on Mar. 26, 2021.

(51) Int. Cl. G06V 10/98; G06V 40/10; G06V 40/13; G06T 11/00; H04N 5/232; G06V 40/12

(52) U.S. Cl. CPC G06V 10/993; G06V 40/155; G06V 40/1318; G06T 11/001; H04N 5/23222; H04N 5/232939; G06V 40/1347

(57) ABSTRACT

Systems and methods for using a mobile device camera to capture photos of latent fingerprints are disclosed. Various embodiments disclosed implement machine learning and pattern matching algorithms to determine the quality of the captured photo of a latent fingerprint. The quality determined by the algorithms may be used to provide feedback to a user (e.g., a CSI) such that the user can capture higher quality images that improve the reliability in using the fingerprint for search and/or matching.

### PRIORITY CLAIM

This application claims priority to U.S. Provisional Patent Appl. No. 63/166,595 to Wei et al., filed Mar. 26, 2021, which is incorporated by reference as if fully set forth herein.

### BACKGROUND

### 1. Field of the Invention

The disclosed embodiments generally relate to systems and methods used for capturing latent fingerprints. Specific embodiments relate to capturing latent fingerprints using camera on a mobile device.

### 2. Description of the Relevant Art

Latent fingerprints may include invisible fingerprint residues left at a scene of crime or on the surface of crime tools. Latent fingerprints can be used, for example, as evidence to be visualized and collected during a crime scene investigation. A typical procedure of latent fingerprint visualization and investigation includes two steps. First, at a crime scene, latent fingerprints are developed and discovered by crime scene investigators (CSIs) using chemical or physical methods (e.g., applying powder on fingerprint to turn it visible). Second, the developed latent fingerprint can be photographed and sent to latent fingerprint examiners.

Currently, a crime scene investigator (CSI) typically uses a digital camera to take photos of latent fingerprints. The digital photos may then be sent to forensic labs to be evaluated and analyzed by fingerprint experts using computer software. In various instances, the CSI may be worried that the images may not be taken clear enough to retain all the details of the print. Thus, it is common for a CSI to take multiple photos of the same fingerprint. These photos must be manually indexed, annotated, evaluated, and analyzed by the forensic lab, which creates a considerable workload and can result in a large backlog and turn-around time at the forensic lab.

Aided by computers, the fingerprint examiner may enhance the image quality, extract legible fingerprint detail, and conduct a search-and-match among an existing fingerprint database. This two-step approach has typically been the only choice since the image processing and fingerprint search-and-match are computationally intensive and thus not feasible for on-site portable devices. There are also additional drawbacks in the two-step approach in that the fingerprint analysis and identification are conducted off-site and merely based on a handful of photos, while the fingerprint examiner is not able to access the rich information (e.g., location of the fingerprint and environment of the crime scene) presented in the live crime scene. Even further, this process is an “open-loop” that does not provide any feedback on the image quality. For example, if the photos are later found to be of unsatisfactory quality, reentering the crime scene and retaking photos may involve voluminous procedures (e.g., a new search warrant), if it is even possible at all.

### BRIEF DESCRIPTION OF THE DRAWINGS

Embodiments disclosed herein are not limited to any specific devices. The drawings described herein are for illustration purposes only and are not intended to limit the scope of the embodiments.

FIG. 1 depicts a representation of an embodiment of a mobile device including a camera.

FIG. 2 depicts a representation of an embodiment of a processor included in a mobile device.

FIG. 3 depicts an example image of a latent fingerprint without any digital overlays.

FIGS. 4-8 depict various example images of digital overlays on the latent fingerprint of FIG. 3.

FIG. 9 is a flow diagram illustrating a method for assessing quality of a latent fingerprint, according to some embodiments.

FIG. 10 is a block diagram of one embodiment of a computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION OF THE PREFERRED EMBODIMENTS

More recent technology has allowed more and more computational power to be provided in mobile devices. Thus, on-site and real-time fingerprint analysis may no longer be a prohibitive task. The present disclosure describes methods and systems for using a mobile device camera (rather than a digital camera) to capture photos of latent fingerprints.

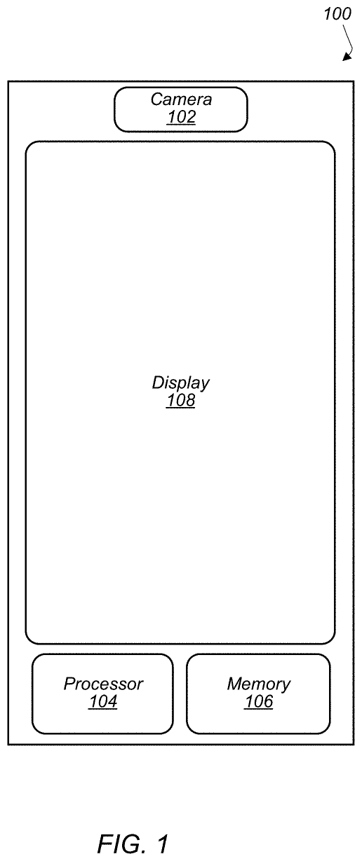

FIG. 1 depicts a representation of an embodiment of a mobile device including a camera. In certain embodiments, mobile device 100 includes camera 102, processor 104, memory 106, and display 108. Device 100 may be a small computing device, which may be, in some cases, small enough to be handheld (and hence also commonly known as a handheld computer or simply a handheld). In certain embodiments, device 100 is any of various types of computer systems devices which are mobile or portable and which perform wireless communications using WLAN communication (e.g., a “mobile device”). Examples of mobile devices include mobile telephones or smart phones, and tablet computers. Various other types of devices may fall into this category if they include wireless or RF communication capabilities (e.g., Wi-Fi, cellular, and/or Bluetooth), such as laptop computers, portable gaming devices, portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (or combination of devices) which is easily transported by a user and capable of wireless communication using, for example, WLAN, Wi-Fi, cellular, and/or Bluetooth. In certain embodiments, device 100 includes any device used by a user with processor 104, memory 106, and display 108.

In certain implementations described herein, camera 102 is a rear-facing camera on device 100. Using a rear-facing camera may allow a live image view on display 108 as the images are being captured by camera 102. Display 108 may be, for example, an LCD screen, an LED screen, or touchscreen. In some embodiments, display 108 includes a user input interface for device 100 (e.g., the display allows interactive input for the user). Display 108 may be used to display photos, videos, text, documents, web content, and other user-oriented and/or application-oriented media. In certain embodiments, display 108 displays a graphical user interface (GUI) that allows a user of device 100 to interact with applications operating on the device. The GUI may be, for example, an application user interface that displays icons or other graphical images and objects that represent application programs, files, and commands associated with the application programs or files. The graphical images and/or objects may include windows, fields, dialog boxes, menus, buttons, cursors, scrollbars, etc. The user can select from these graphical images and/or objects to initiate functions associated with device 100.

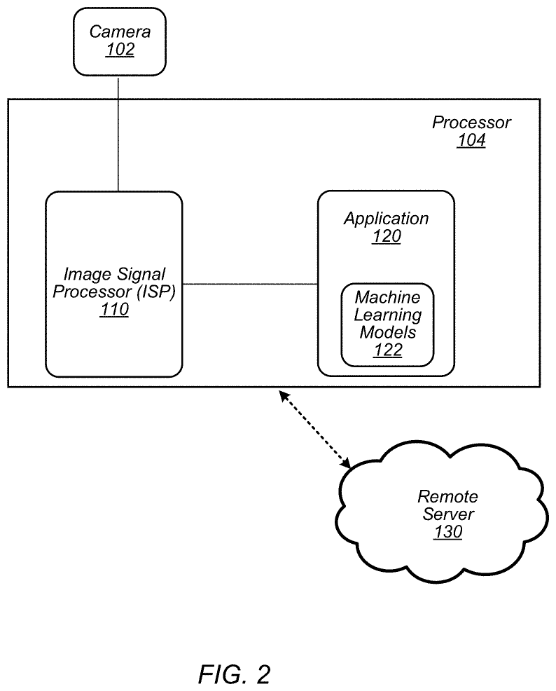

In various embodiments, fingerprint images captured by camera 102 may be processed by processor 104. FIG. 2 depicts a representation of an embodiment of processor 104 included in device 100. Processor 104 may include circuitry configured to execute instructions defined in an instruction set architecture implemented by the processor. Processor 104 may execute the main control software of device 100, such as an operating system. Generally, software executed by processor 104 during use may control the other components of device 100 to realize the desired functionality of the device. The processors may also execute other software. These applications may provide user functionality, and may rely on the operating system for lower-level device control, scheduling, memory management, etc.

In certain embodiments, processor 104 includes image signal processor (ISP) 110. ISP 110 may include circuitry suitable for processing images (e.g., image signal processing circuitry) received from camera 102. ISP 110 may include any hardware and/or software (e.g., program instructions) capable of processing or analyzing images captured by camera 102. In certain embodiments, application 120 performs analysis and other tasks on images captured and processed by ISP 110. Application 120 may be, for example, an application (e.g., an “App”) on the mobile device that is implemented to analyze and evaluate real-time (e.g., live-captured) images of latent fingerprints.

In certain embodiments, application 120 operates one or more machine learning models 122. Machine learning models 122 may include, for example, neural networks or machine learning algorithms. Machine learning models 122 may include any combination of hardware and/or software (e.g., program instructions) located in processor 104 and/or on device 100. In various embodiments, machine learning models 122 include circuitry installed or configured with operating parameters that have been learned by the models or similar models (e.g., models operating on a different processor or device). For example, a machine learning model may be trained using training images (e.g., reference images) and/or other training data to generate operating parameters for the machine learning circuitry. The operating parameters generated from the training may then be provided to machine learning models 122 installed on device 100. Providing the operating parameters generated from training to machine learning models 122 on device 100 allows the machine learning models to operate using training information programmed into the machine learning models (e.g., the training-generated operating parameters may be used by the machine learning models to operate on and analyze images captured by the device).

In certain embodiments, application 120 provides feedback to a user (e.g., a CSI or other image taker) regarding the quality of the images being captured with the feedback being provided in real-time to allow the user to view the image quality and/or retake to capture higher quality images. In some embodiments, application 120 guides the user to capture/take photos more judiciously, which may result in less photos needed to be captured and higher quality images. For instance, the user can be guided by application 120 to take photos and know the photo's quality immediately. Therefore, the user can retake photos many times until a satisfying photo (or series of photos) is taken, and only submit the highest quality ones to the forensic lab. Additionally, using application 120 on device 100 may result in less workload at the forensic lab and higher quality fingerprint photos being submitted to the lab. Higher quality photos may also enhance efficiency of the forensic lab. The described method essentially provides a “closed-loop” latent print evidence collection process that enhances the quality of the latent fingerprint photos and reduces the number of low-quality ones.

In various embodiments application 120 facilitates on-site and real-time latent fingerprint identification and analysis at a crime scene. For instance, in one use scenario, a user (e.g., CSI) at the crime scene opens application 120 on device 100 and points camera 102 toward a location of a latent fingerprint. In some embodiments, as described above, camera 102 may be a rear-facing camera on device 100 to allow a live image view on display 108. Application 120 may be pre-trained with a machine learning algorithm (e.g., machine learning models 122) and is able to enhance images and identify fingerprints in real-time. In various embodiments, the user can change the condition(s) under which the latent print is presented to the application. For example, the user may illuminate the print with different light source(s), change the exposure(s), and change the angle(s) and distance(s) of the camera relative to the fingerprint. In certain embodiments, application 120 compares images taken under different conditions and guides the user to take the photo that preserves the most legible detail of the latent fingerprint.

As described herein, application 120 on device 100 assists the process of latent fingerprint acquisition. In various embodiments, application 120 uses camera 120 integrated on device 100 to capture latent fingerprints. In certain embodiments, application 120 indicates the quality of the photos of such fingerprints with both a graphical color-map and a numerical reliability score in real-time (e.g., at or near the time the photo is captured). As such, application 120 assists crime scene investigators (CSIs) in capturing optimal black-on-white fingerprint image(s).

In certain embodiments, application 120 implements artificial intelligence (AI) to assist the process of latent fingerprint acquisition. AI may be implemented, for example, as machine learning models 122 (such a machine learning algorithm) or other algorithms (such as pattern matching algorithms), described herein. In various embodiments, application 120 runs a real-time algorithm to identify usable and unusable areas of a latent fingerprint image. In some embodiments, a graphical indicator may indicate useable or unusable fingerprint areas in the captured image determined by the algorithm (e.g., a machine learning algorithm or a pattern matching algorithm). The graphical indicator may be a graphical color-map with two or more different colors used to indicate useable or unusable fingerprint areas. For example, the graphical color-map may include green (useable) and red (unusable) to indicate the different fingerprint areas. In some embodiments, application 120 may leverage techniques such as augmented reality (AR) to provide the graphical indicators to inform the user of the quality of the captured image.

In certain embodiments, application 120 generates a numerical score for the captured image. The numerical score may be, for example, evaluated based on the overall fingerprint quality in the captured image. The higher the numerical score, the higher the overall fingerprint quality in the captured image and the more likely a fingerprint match can be found using the fingerprint in the captured image. As described herein, application 120 may make it possible for CSIs to determine the optimal camera angles, distance, illumination, etc., during latent fingerprint acquisition (e.g., in real-time), thereby enhancing the quality of the acquired latent fingerprint image(s).

As described above, application 120 is able to provide on-site assistance to the user and maximize the value of fingerprint evidence. In some embodiments, latent fingerprint photos with sufficient quality as determined by application 120 are transmitted to a remote server (e.g., remote server 130) over the cloud. Remote server 130 may conduct computationally heavy tasks, such as fingerprint feature detection and fingerprint search-and-match (for example, using automated fingerprint identification system (AFIS)). Results from these tasks may then be sent back to device 100 for presentation to the CSI on display 108 through application 120.

In various embodiments, application 120 is implemented to capture images and store the images in a photo gallery on device 100 (e.g., in memory 106 of the device). In some embodiments, algorithms implemented by application 120 for determining graphical indicators and numerical scores include algorithms based on fingerprint analysis and matching applications and/or modifications of fingerprint analysis and matching applications. One example of a fingerprint analysis and matching application that may be implemented is SourceAFIS (which is an open-source fingerprint analysis and matching project). In some contemplated embodiments, additional algorithms may be implemented on device 100 that allow accepting of images from application 120 for conducting 1:1 fingerprint matching or 1:N fingerprint searching.

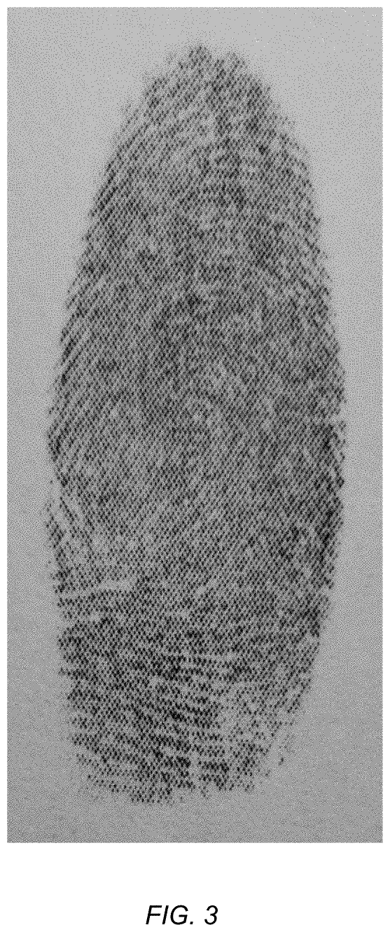

In certain embodiments, application 120 displays digital overlays in real-time as the application analyzes fingerprints. Overlays may include, but not be limited to, contrast masks, ridge angle masks, thinned and traced skeletons, skeleton minutiae, and numbers representing blocks or pixels being actively analyzed. In various embodiments, contrast and image orientation within blocks or pixels are used to find fingerprint minutiae and determine distances between them to create a table template for fingerprint matching. FIG. 3 depicts an example image of a latent fingerprint without any digital overlays.

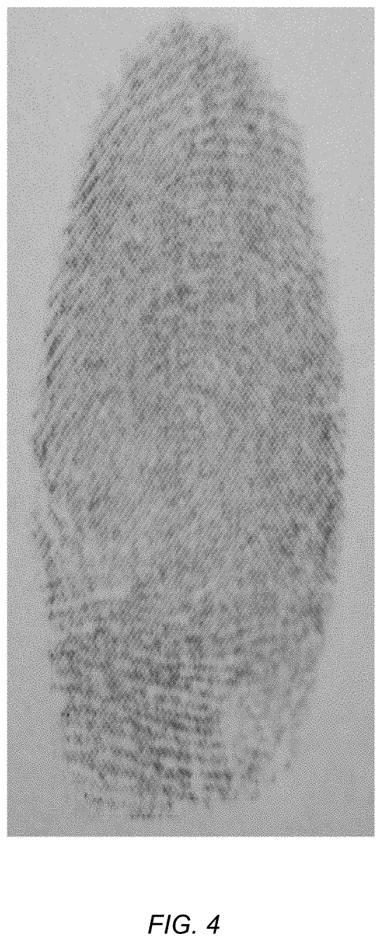

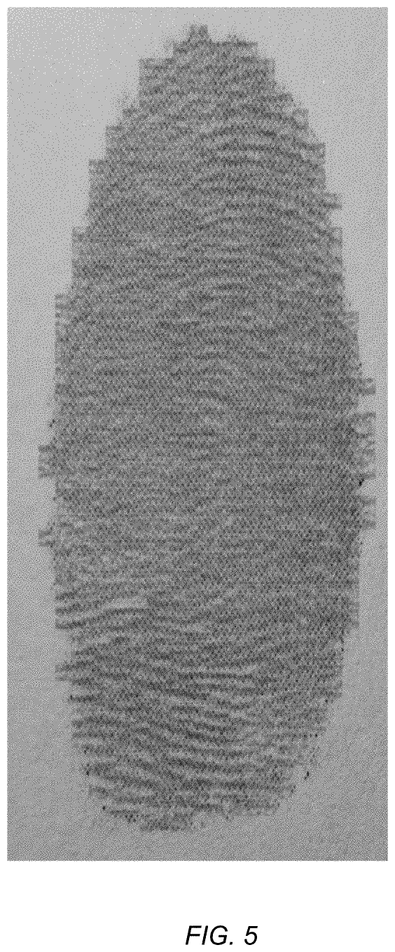

FIGS. 4-8 depict various example images of digital overlays on the latent fingerprint of FIG. 3. FIGS. 4-8 depict overlays that are implemented as various stages in the algorithm(s) applied by application 120 to analyze the fingerprint of FIG. 3. FIG. 4 depicts a digital filtered mask overlay that takes contrast into consideration. The filtered mask overlay in FIG. 4 is a basic filter that may be used for latent fingerprint valid area detection. In various embodiments, application 120 applies the subsequent algorithm(s) on the filtered mask overlay in FIG. 4 for additional analysis of the latent fingerprint, as shown in FIGS. 5-8.

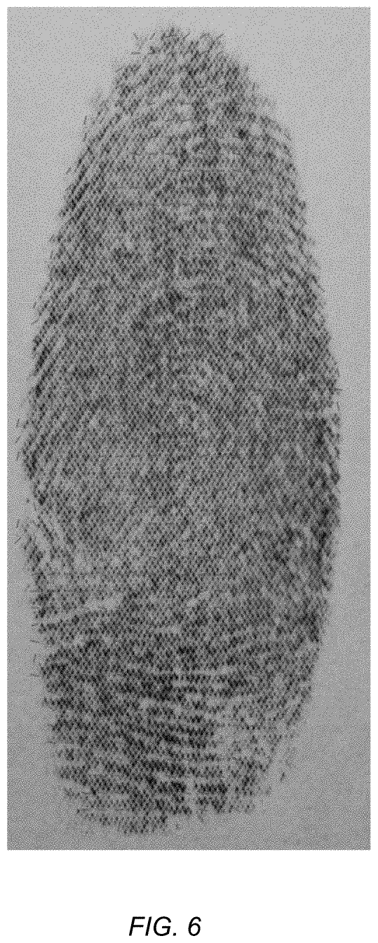

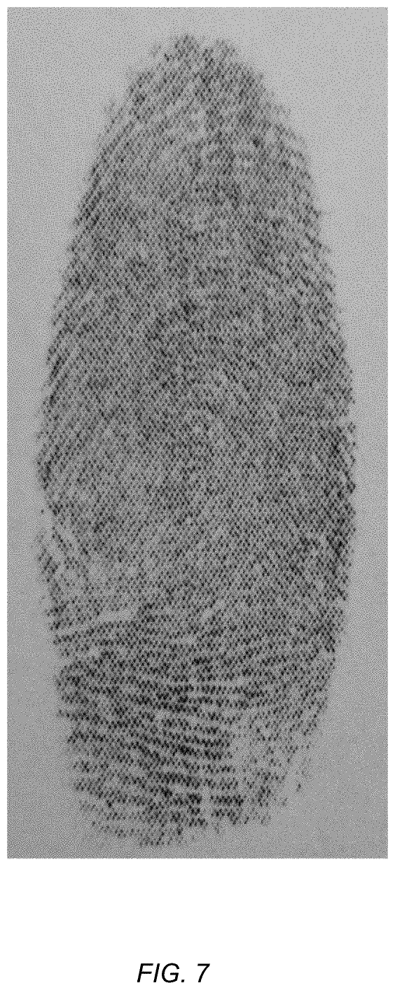

FIG. 5 depicts a digital overlay that provides visual detail as given by pixel angle. In FIGS. 5, 90° to 270° is indicated by blue and 0° to 180° is indicated by red. FIG. 6 depicts a digital that is a ridge angle overlay mask. In FIG. 6, the angle is calculated within each block and then averaged again with neighboring blocks for smoothed orientation. FIG. 7 depicts a digital skeleton overlay. In FIG. 7, the previous stages of the algorithm from FIGS. 4-6 are used to derive a skeleton for fingerprint ridges as well as a skeleton for fingerprint valleys.

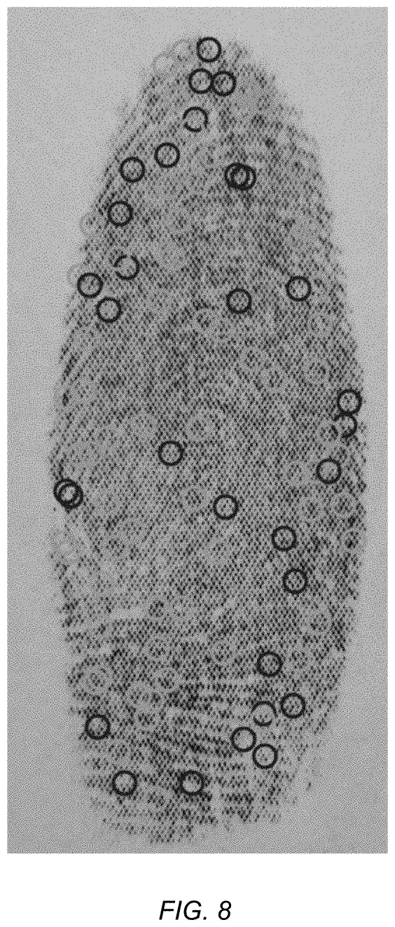

FIG. 8 depicts a digital overlay showing a final stage of the algorithm(s) implemented by application 120 before constructing the template minutiae used for fingerprint matching. In FIG. 8, circle bifurcations are in green and ridge endings are in blue. Only endings attached to a ridge are circled. In some contemplated embodiments, each stage of digital overlay implemented by application 120 (such as shown in FIGS. 3-8) may be displayed on display 108 in real-time for the user of device 100. Thus, the user may be able to visualize the different stages of the algorithm implemented by application 120. In various embodiments, the digital overlay of the number of blocks or pixels being actively analyzed assists in providing optimized photo capturing by application 120.

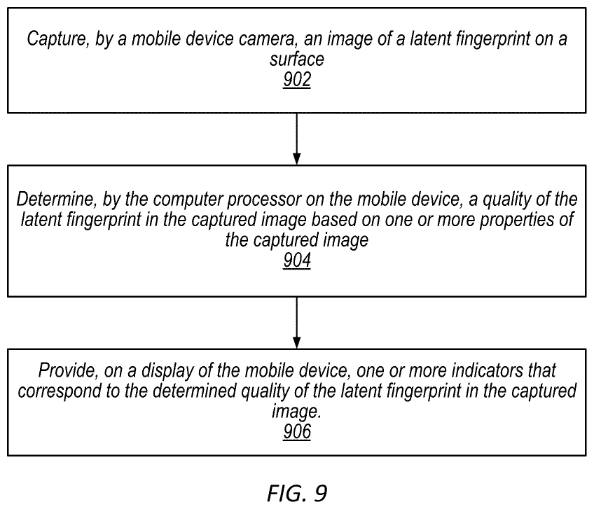

FIG. 9 is a flow diagram illustrating a method for assessing quality of a latent fingerprint, according to some embodiments. The method shown in FIG. 9 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system, such as computing device 1010, described below.

At 902, in the illustrated embodiment, a camera on a mobile device captures an image of a latent fingerprint on a surface.

At 904, in the illustrated embodiment, a computer processor on the mobile device determines a quality of the latent fingerprint in the captured image based on one or more properties of the captured image.

At 906, in the illustrated embodiment, one or more indicators that correspond to the determined quality of the latent fingerprint in the captured image are provided on a display of the mobile device.

### Example Computer System

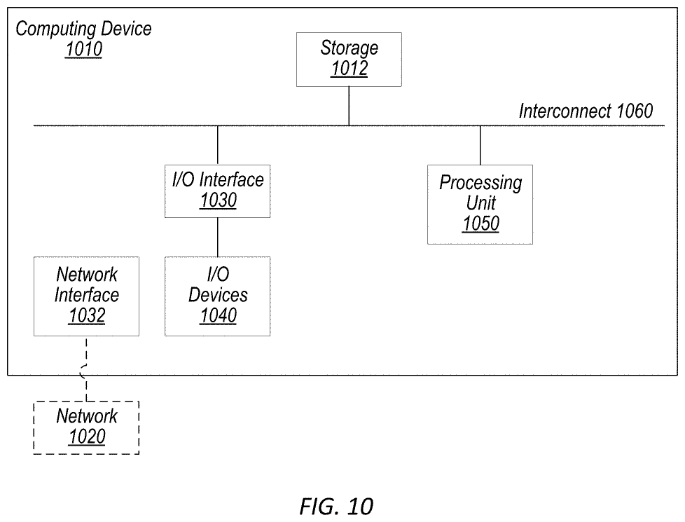

Turning now to FIG. 10, a block diagram of one embodiment of computing device (which may also be referred to as a computing system) 1010 is depicted. Computing device 1010 may be used to implement various portions of this disclosure. Computing device 1010 may be any suitable type of device, including, but not limited to, a personal computer system, desktop computer, laptop or notebook computer, mainframe computer system, web server, workstation, or network computer. As shown, computing device 1010 includes processing unit 1050, storage 1012, and input/output (I/O) interface 1030 coupled via an interconnect 1060 (e.g., a system bus). I/O interface 1030 may be coupled to one or more I/O devices 1040. Computing device 1010 further includes network interface 1032, which may be coupled to network 1020 for communications with, for example, other computing devices.

In various embodiments, processing unit 1050 includes one or more processors. In some embodiments, processing unit 1050 includes one or more coprocessor units. In some embodiments, multiple instances of processing unit 1050 may be coupled to interconnect 1060. Processing unit 1050 (or each processor within 1050) may contain a cache or other form of on-board memory. In some embodiments, processing unit 1050 may be implemented as a general-purpose processing unit, and in other embodiments it may be implemented as a special purpose processing unit (e.g., an ASIC). In general, computing device 1010 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage 1012 is usable by processing unit 1050 (e.g., to store instructions executable by and data used by processing unit 1050). Storage 1012 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage 1012 may consist solely of volatile memory, in one embodiment. Storage 1012 may store program instructions executable by computing device 1010 using processing unit 1050, including program instructions executable to cause computing device 1010 to implement the various techniques disclosed herein.

I/O interface 1030 may represent one or more interfaces and may be any of various types of interfaces configured to couple to and communicate with other devices, according to various embodiments. In one embodiment, I/O interface 1030 is a bridge chip from a front-side to one or more back-side buses. I/O interface 1030 may be coupled to one or more I/O devices 1040 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A mobile device, comprising:
a computer processor;
a memory;
a display;
a camera;
circuitry coupled to the camera and the display, wherein the circuitry is configured to:
capture an image of a latent fingerprint on a surface using the camera;
determine a quality of the latent fingerprint in the captured image based on one or more properties of the captured image; and
provide one or more indicators on the display that correspond to the determined quality of the latent fingerprint in the captured image.

2. The mobile device of claim 1, wherein at least one of the indicators is a graphical indicator of the quality of the latent fingerprint in the captured image.

3. The mobile device of claim 2, wherein the graphical indicator indicates useable and unusable areas of the latent fingerprint in the captured image.

4. The mobile device of claim 2, wherein the graphical indicator includes a graphical color-map overlayed on an image of the latent fingerprint.

5. The mobile device of claim 4, wherein the graphical color-map includes two or more different colors to indicate useable and unusable areas of the latent fingerprint in the captured image.

6. The mobile device of claim 1, wherein at least one of the indicators is a numerical score indicator of the quality of the latent fingerprint in the captured image.

7. The mobile device of claim 6, wherein the numerical score indicator is a numerical reliability indicator of the quality of the latent fingerprint in the captured image.

8. The mobile device of claim 6, wherein the numerical score indicator is evaluated based on an overall fingerprint quality of the latent fingerprint in the captured image.

9. The mobile device of claim 6, wherein the numerical score indicator is determined using one or more algorithms based on fingerprint analysis and matching applications.

10. The mobile device of claim 6, wherein a higher value of the numerical score indicator indicates a higher quality of the latent fingerprint in the captured image.

11. The mobile device of claim 1, wherein the one or more indicators provide feedback to a user of the device on the quality of the latent fingerprint in the captured image.

12. The mobile device of claim 11, wherein the feedback is provided in real-time on the display to allow the user to improve the quality of the latent fingerprint in subsequently captured images.

13. The mobile device of claim 11, wherein the feedback includes identification of one or more properties in the captured image affecting the quality of the latent fingerprint in the captured image.

14. The mobile device of claim 1, wherein the quality of the latent fingerprint in the captured image is determined using one or more machine learning algorithms programmed in the circuitry of the mobile device.

15. A method, comprising:
capturing an image of a latent fingerprint on a surface using a camera located on a mobile device, the mobile device having a computer processor, a memory, and a display;
determining, by the computer processor, a quality of the latent fingerprint in the captured image based on one or more properties of the captured image; and
providing, on the display, one or more indicators that correspond to the determined quality of the latent fingerprint in the captured image.

16. The method of claim 15, further comprising providing the one or more indicators as graphical indicators on the display.

17. The method of claim 15, further comprising providing the one or more indicators in a graphical color-map overlayed on an image of the latent fingerprint on the display.

18. The method of claim 15, wherein at least one of the indicators is a numerical score indicator of the quality of the latent fingerprint in the captured image.

19. The method of claim 15, wherein the quality of the latent fingerprint in the captured image is determined using one or more machine learning algorithms operated by the computer processor.

20. The method of claim 15, further comprising providing an identification of one or more properties in the captured image affecting the quality of the latent fingerprint in the captured image.
